(19) United States
(12) Patent Application Publication
(10) Pub. No.: US 2010/0002006 A1
(43) Pub. Date: Jan. 7, 2010

(54) Modal Multiview Display Layout

(75) Inventors: J. William Mauchly, Berwyn, PA (US); Joseph T. Friel, Ardmore, PA (US); Philip R. Graham, Milpitas, CA (US)

Correspondence Address: EDELL, SHAPIRO & FINNAN, LLC, 1901 RESEARCH BOULEVARD, SUITE 400, ROCKVILLE, MD, 20850, US

(73) Assignee: CISCO TECHNOLOGY, INC., San Jose, CA (US)

(21) Appl. No.: 12/166,982

(22) Filed: Jul. 2, 2008

(51) Int. Cl. G09G 3/00

(52) U.S. Cl. 345/581

(57) ABSTRACT

A system and method for providing a plurality of viewing angles and images on a display. An embodiment comprises a display system where a user has the option of determining the number of images to view and the range of viewable angles for each image. A display system is configured to display a maximum number of images at different viewing angles by interlacing a plurality of images so that each viewing angle shows a selected image. The display system provides a method by which an operator can increase the viewing area of an image by interlacing the same image to more than one viewing angle.

### BACKGROUND

For many years, the resolution of displays, especially plasma or liquid crystal display (LCD) systems, has increased significantly, which has benefited the user in sharper high resolution images. In addition to increased resolution, LCD and plasma displays provide system designers with an ability to show multiple images on a single display. In videoconferencing situations for example, individual participants might desire to view off-site participants from different angles to create a more seamless virtual environment. To accomplish this using traditional displays would require one display for each image viewed. Besides being cost prohibitive, this method often is not feasible because of space constraints.

Using a parallax barrier, a screen with vertical transmissive slits separated by opaque regions set in front of the display to restrict light transmitted through the pixels of certain output angles, multiple images can be displayed on the same display. Other technology, such as lenticular lenses (curved lenses fitted to a display), or angled light pipes have also been used to create multiple images on one display. By interlacing a plurality of images into one video signal where individual images are assigned specific pixel groups within the display screen, and using one of the methods above to direct light from individual pixel groups to specific angles, users positioned at these various angles can see one image from the plurality of interlaced images. This way, multiple users can position themselves in front of a modified display and each user would see a different image depending on the angle at which they were viewing the display.

Because the different images are viewed at different angles, users need to position themselves at particular locations to view the associated images. As the number of images increases for each display, the range of viewable angle for each image decreases. Current multi-view display systems have a fixed number of images that can be viewed and have fixed ranges of viewing angles. While this method works, in some situations challenges are presented.

For example, in videoconferencing situations, while it is desirable to have displays capable of showing multiple images, the restriction on the range of viewing angles can be problematic when the number of participants viewing the videoconference increases. As the number of participants viewing a particular image at a particular angle increases, it becomes more difficult to fit all the participants into the range of viewable angles. When the number of viewers is large, it is desirable to have a wider range of viewable angles, possibly sacrificing the number of possible images shown on the display. When the number of viewers is small, it is desirable to have more images shown on the display, possibly sacrificing the range of viewable angles for each image.

Some display systems currently have the ability to show multiple views. However, because of the angles required to display multiple views, there is a negative relationship between the number of images and the range of viewable angles for each image. As the number of images increases the range of viewing angles decreases. Systems with many images are not suited for situations where there are many viewers because the “sweet spot” where the video image is clear is small. Systems with large viewing angles are not suited for situations where many images are needed on a single display.

Therefore, what is desired are systems and methods that overcome challenges found in the art, including a method for dynamically changing the range of viewing angles and the number of images shown on a display.

### BRIEF DESCRIPTION OF THE DRAWINGS

FIG. 1a illustrates a simplified, non-limiting example light from pixel columns on a display being affected by a parallax barrier.

FIG. 1b illustrates a simplified, non-limiting example of the relationship between the parallax barrier distance from the pixel columns on the display and the viewing angle.

FIG. 1c illustrates a simplified, non-limiting example of the effect on the viewing angles as the parallax barrier is shifted.

FIG. 2a illustrates a simplified, non-limiting example of the interlacing of images onto different pixel columns of a display to create multiple images viewable from different angles.

FIG. 2b illustrates a simplified, non-limiting example of some possible viewing angles in a multiview display.

FIG. 3a illustrates a simplified, non-limiting example of how the viewing angles for a specific image is modulated over the linear length of a display.

FIG. 3b illustrates a simplified, non-limiting example of the blurring effect created by crossover points between the viewable angles.

FIGS. 4a, 4b and 4c illustrate non-limiting examples of how “sweet spots” vary depending on the viewing angle.

FIG. 4d illustrates a simplified, non-limiting example of a “sweet spot” when multiple displays are used.

FIG. 5a illustrates a simplified, non-limiting example of a method for increasing the area of a “sweet spot” for a multi-display system by interlacing the same image onto multiple viewing angles.

FIGS. 5b and 5c illustrate examples of the method for increasing the area of a “sweet spot” by interlacing the same image onto adjacent viewing angles.

FIG. 6a illustrates a simplified, non-limiting embodiment showing how the “sweet spot” for viewing images are interlaced from a pixel column perspective.

FIG. 6b illustrates another simplified, non-limiting embodiment showing how the “sweet spot” for viewing images are interlaced from a pixel column perspective.

FIG. 7 illustrates a simplified, non-limiting block diagram showing select components of a system according to one embodiment.

FIG. 8 illustrates an example of a flow chart depicting a display method according to an embodiment.

### DESCRIPTION OF EXAMPLE EMBODIMENTS

Overview

Embodiments can be understood in the context of a multi-view display where the display is setup to show a plurality of images viewable from different angles with respect to the surface plane of the display. Users viewing the display may increase or decrease the range of viewing angles for a particular image by changing the configuration of the interlaced images shown on the display. In accordance with an embodiment, to create the multi-view display, a flat panel display is configured with one of a plurality of methods to create a multi-view, multi-image display system. A plurality of images are interlaced such that each image in the plurality of images is associated with specific columns of pixels in the display. The pixel groups associated with a particular image in the plurality of images are configured to display the images at an angle different from pixel groups associated with other images in the plurality of interlaced images. In an embodiment, a parallax barrier may be used for creating the multi-view, multi-image effect on the display. The parallax barrier limits the visibility of each pixel column to a specific angle or range of angles. By changing the relative positioning of the barrier, different numbers of viewing angles and spacing between the viewing angles can be created. Thus, a method is provided comprising configuring a display to provide a plurality of viewing angles; interlacing image data associated with each of a plurality of images such that each viewing angle displays a selected one of the plurality of images; and adjusting a viewing angle for at least one of the plurality of images. In addition, a display system is provided comprising system comprising a display device configured to provide a plurality of viewing angles; a video interlacing device operably connected to the display and configured to interlace image data for each of a plurality of images into a video stream such that each viewing angle displays a selected one of the plurality of images; and a controller device operably connected to the video interlacing device, wherein the controller device is configured to change a range of viewing angles for at least one of the plurality of images.

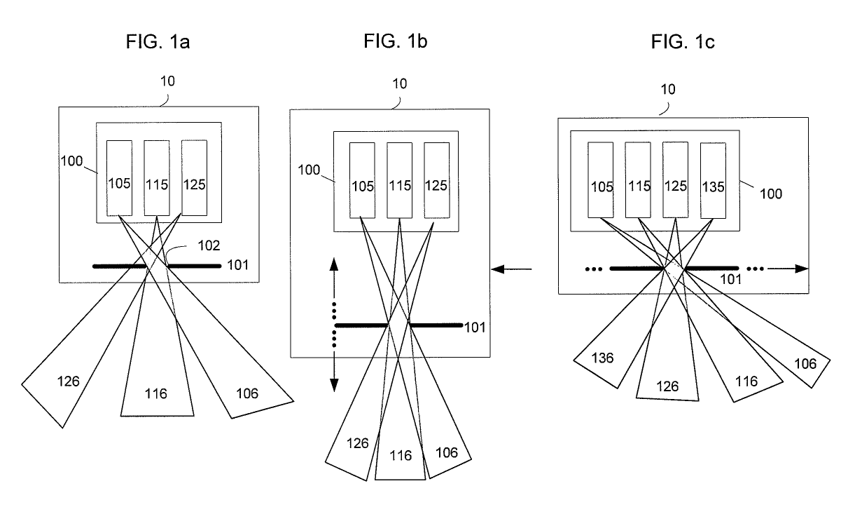

FIG. 1a illustrates a simplified non-limiting example of a parallax barrier used to create multiple views. In this illustration, a display device is provided shown generally at reference numeral 10 and comprising a flat panel display unit (e.g., a LCD display panel) 100 comprising a plurality of groups of pixels. For example, the pixel groups comprise columns of pixels and in the example shown in FIG. 1a, three columns of pixels 105, 115, 125 from a plurality of pixel columns of a flat panel display unit 100 are shown. The display unit 10 further comprises a parallax barrier 101 having a light blocking panel body with a plurality of vertical slits, only of which is shown for simplicity in FIG. 1a, at reference numeral 102. The parallax barrier 101 is attached or otherwise positioned proximate to the viewing surface of the display unit 10. Because the light emitted from each pixel is restricted to the vertical slits, light 106, 116, 126 from each of the pixel columns 105, 115, 125 is viewable from different angles relative to the plane of the viewing surface of the display.

In an embodiment, to create the multi-view, multi-image effect, each pixel column 105, 115, 125 displays a unique image interlaced from a plurality of images. Repeating this method for the plurality of pixel columns in a display, the plurality of interlaced images may be displayed to viewers at different angles such that a viewer in a first position will see a first image from the plurality of interlaced images while a viewer in a second position will see a second image from the plurality of interlaced images, and so on.

FIG. 1b illustrates how the viewing angles can be altered by moving the parallax barrier 101 closer or farther away from the display. As the parallax barrier 101 is moved away from the pixel columns 105, 115, 125 of the flat panel display unit 100, the range of viewable angles 106, 116, 126 associated with each pixel decreases. The range of viewing angles 106, 116, 126 increases as the parallax barrier 101 is moved closer to the flat panel display unit 100.

FIG. 1c illustrates how the viewing angles are altered by moving the parallax barrier 101 in directions parallel to the viewing surface of the flat panel display unit 100. In this illustration, four pixel groups (e.g., columns) are shown at reference numerals 105, 115, 125 and 135. Each pixel column displays a unique image from the plurality of interlaced images. As the parallax barrier 101 is moved in directions parallel to the viewing surface of the display, the viewing angles 106, 116, 126, and 136 for the associated column pixels 105, 115, 125, and 135 change as compared to those of FIG. 1a.

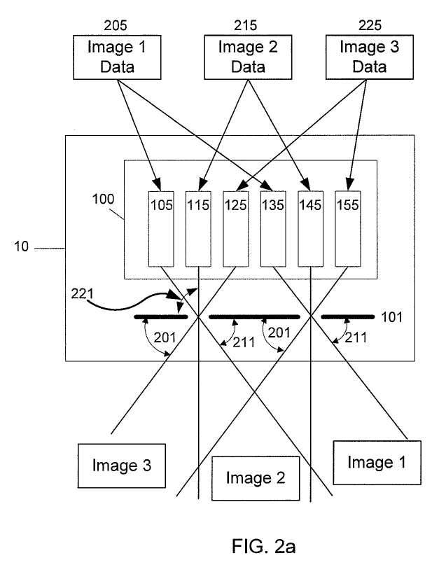

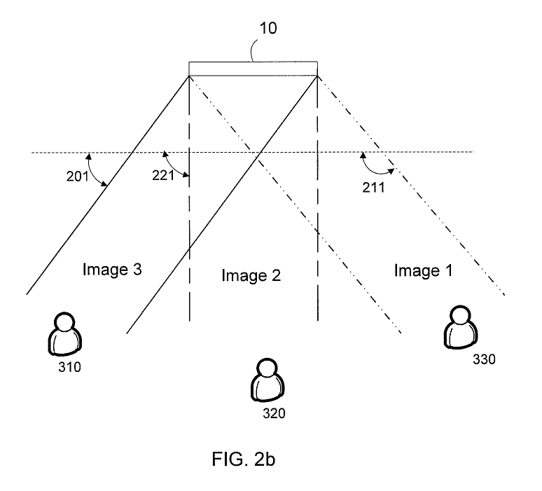

FIG. 2a illustrates a simplified non-limiting example of multiple images being interlaced and displayed. In this illustration, three images, Image 1, Image 2 and Image 3, are displayed by interlacing their respective image data shown at reference numerals 205, 215, 225 on different column pixels. It is understood that this is an example and that more or fewer images are contemplated within the scope of embodiments described herein. For example, the Image 1 data 205 is displayed on two pixel columns 105, 135. The Image 2 data 215 is displayed on two pixel columns 115, 145. The Image 3 data 225 is displayed on the next two columns 125, 155. The parallax barrier 101 restricts the visibility of the pixel columns to different angles 201, 211, 221.

FIG. 2b illustrates a simplified example of the principles shown in FIG. 2a, wherein the display device 10 displays three separate images, Image 1, Image 2 and Image 3 that are viewable by respective individual viewers at different positions with respect to the display device 10. For example, Image 1 is viewed by individual 330, Image 2 is viewed by individual 320 and Image 3 is viewed by individual 2b applied to an entire display.

In an embodiment, the pixel columns associated with an interlaced image are distributed across the flat display panel of the display device 10. The viewing angle for each pixel column may be modulated or adjusted to account for the linear qualities of the display such that the light from each pixel column in the plurality of pixel columns associated with an image is directed to the same general location.

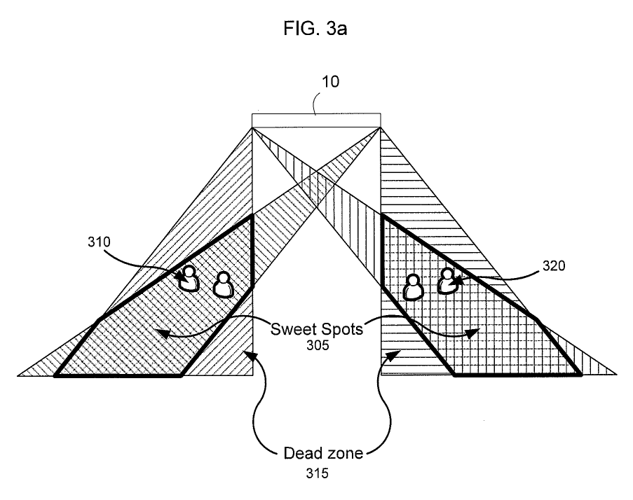

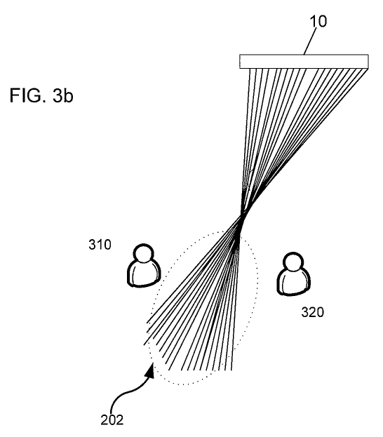

FIG. 3a illustrates an example where viewing angle for an image is adjusted by at one area of the display device 10, such as at the ends of the display device 10. In this example, two images are interlaced and displayed at different angles. By modulating the viewing angles of different pixel columns across the display device 10, the viewers 310 and 320 of the two different images are able to see a complete image. The parallax barrier (not shown) in the display device 10 is configured so that each pixel column associated with an image has a slight variation in the viewable angle. By adjusting the viewing angles of each pixel column, the full image can be viewed when viewers 310 and 320 are positioned in the respective “sweet spot” 305 where all the viewing angles from the plurality of pixel columns for the same image intersect. Because of the variations in the viewing angles, “dead” zones 315 are created. When viewers 310 and 320 position themselves in these “dead” zones, instead of seeing one complete image, the viewers see “ghost” images created from viewing pixel columns associated with different images. In the “sweet spot” 305 the viewers 310 and 320 see one image over the entire display.

FIG. 3b illustrates the blurring effect in locations that are between the viewable angles. Modulating the viewing angles relative to the surface plane of the display creates a crossover effect between the plurality of images. When a viewer is too close to the crossover points 202 between two views, “ghost” images are seen. These “ghost” images are created when a viewer sees pixel columns associated with different interlaced images.

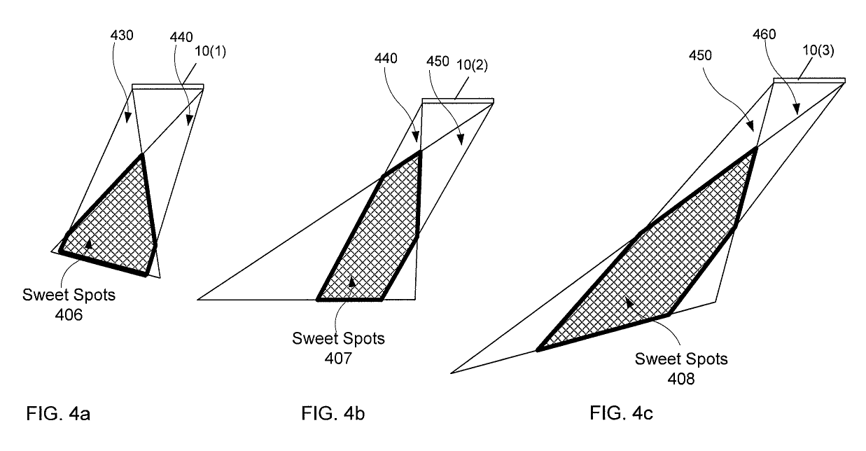

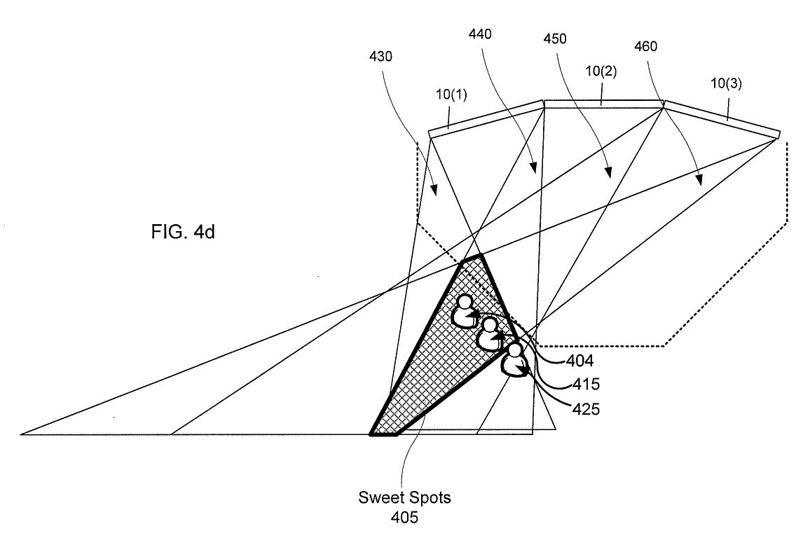

FIGS. 4a-4c illustrates non-limiting examples of how the “sweet spot” varies when the viewing angles are changed. Each triangle 430, 440, 450, 460 represents the range of viewing angles for pixel columns showing a unique image on an associated one of display devices 10(1), 10(2) and 10(3). Since the “sweet spot” is generally defined by the viewing angles of the pixel columns at the ends of the display devices 10(1), 10(2) and 10(3) the plurality of viewing angles associated with pixel columns between the ends are not shown. In this example, three display devices 10(1)-10(3) are configured to display a unique image at different angles. Note, while each display device 10(1), 10(2) and 10(3) is capable of showing multiple images over multiple angles, only one viewing angle from the plurality of possible viewing angles is shown on each display device 10(1), 10(2) and 10(3).

FIG. 4d illustrates how the “sweet spot” decreases in area when multiple displays are added to a system. When multiple display devices 10(1), 10(2) and 10(3) are combined into a unit 20 as shown in FIG. 4d, the “sweet spot” 405 for viewing images decreases in area. Each display device 10(1), 10(2) and 10(3) has a different viewing angle intersecting at a common area. Because of the increased number of views from the three different display devices 10(1), 10(2) and 10(3) the “sweet spot” 405 where all three images from the display devices 10(1), 10(2) and 10(3) are viewable, decreases in area. The “sweet spot” 405 where the three unique images from the displays 100, 410, 420 may all be viewed is the intersection of the individual “sweet spots” 406, 407, 408 associated with the display devices 10(1), 10(2) and 10(3). Here, two viewers 404 and 415 are able to position themselves in the “sweet spot” 405. However, a third viewer 425 is positioned just outside of the “sweet spot” 405 for all three images. Unless there is room behind the other two viewers 405 and 415, the third viewer 425 will see “ghost” images from at least one of the display devices 10(1), 10(2) and 10(3). In this illustration, each display device 10(1), 10(2) and 10(3) may be interlaced with a plurality of images viewable from a plurality of different angles. However, only one image and the associated viewing angle is shown to reduce the clutter of the illustration.

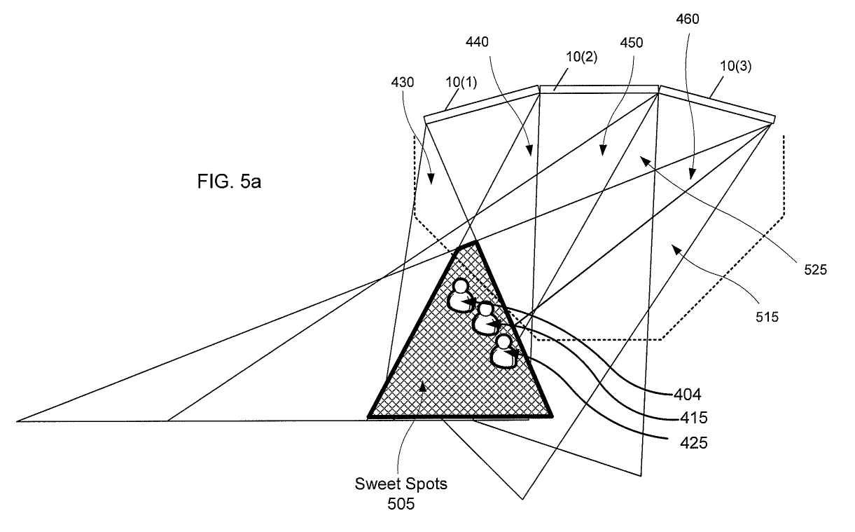

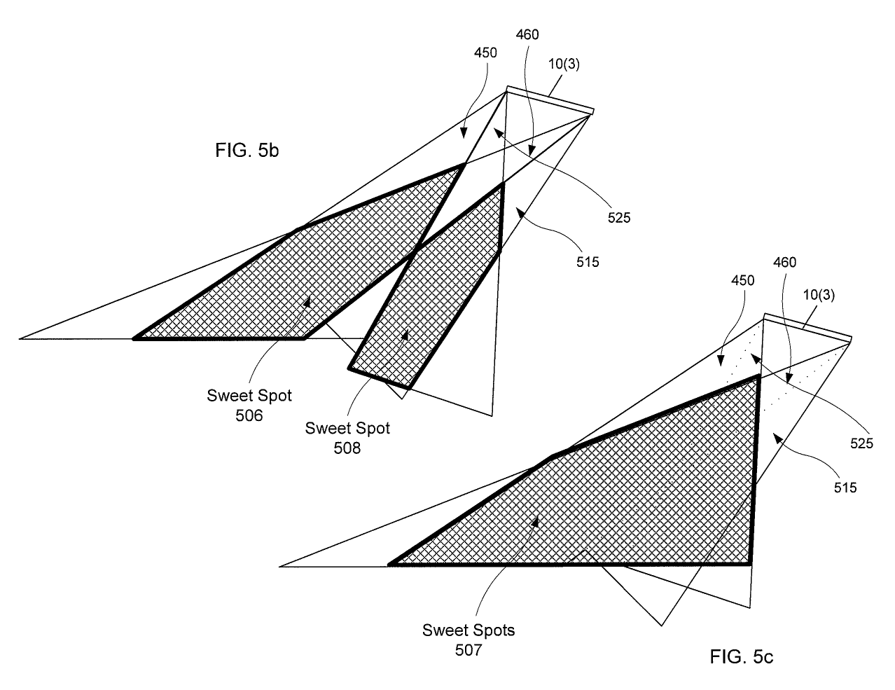

In an embodiment, to increase the area of the “sweet spot”, pixel columns with adjacent viewing angles are interlaced with the same image. While the number of total images shown on the displays is reduced, the viewable area or “sweet spot” for at least one image is increased. FIG. 5a illustrates a simplified non-limiting example where the “sweet spot” 505 for viewing the three images from the three different display devices 10(1), 10(2) and 10(3) is increased by interlacing the same image to an adjacent viewing angle 525, 515 of one display device 10(3). The image previously viewed on the display device 10(3) by the viewers 404, 415 and 425 is now interlaced to the current viewing angles 450 and 460 as well as the adjacent viewing angles 515 and 525.

FIGS. 5b and 5c illustrate how the “sweet spot” for an image is increased by interlacing the same image onto adjacent viewing angles. A “sweet spot” 506 for viewing one image is created by the intersection of the range of viewing angles 450 and 460. This range of viewing angles 450 and 460 represents one of a plurality of viewing angles where a distinct image may be viewed. A second “sweet spot” 508 is created by the intersection of the adjacent range of viewing angles 515, 525 for a second distinct image as shown in FIG. 5b. On the other hand, interlacing the same image to two adjacent ranges of viewing angles 450, 515, 460 and 525 create a larger “sweet spot” 507 or viewable area for the image as shown in FIG. 5c. Three displays are used to illustrate the problem of limited viewing area and how this problem increases when more displays are added. The methods and systems described here are not limited to applications where there are three multi-view displays.

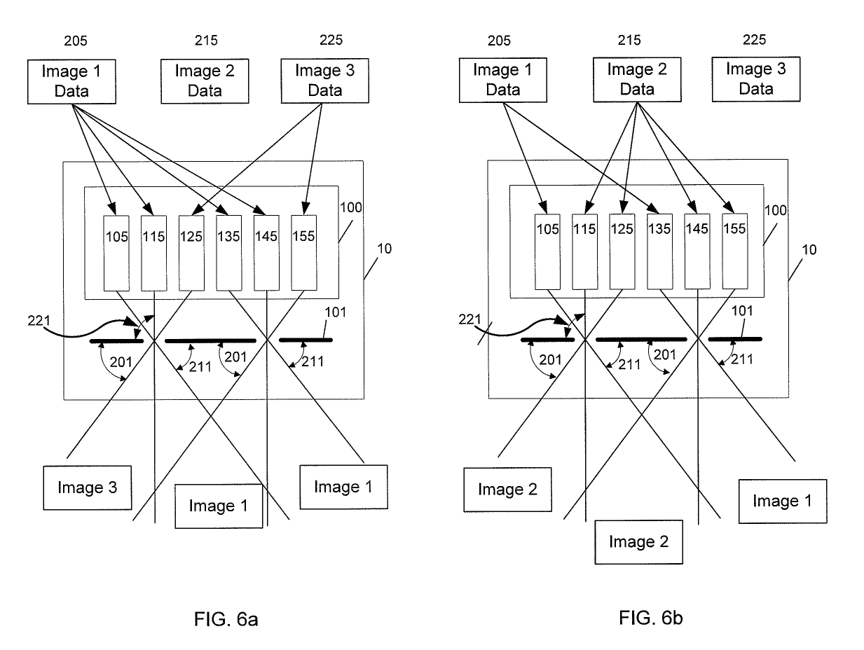

FIG. 6a illustrates how images are interlaced to increase a “sweet spot” or viewable area, and the example case of three images, Image 1, Image 2 and Image 3 is used, produced by their associated image data 205, 215 and 225, respectively. To increase the “sweet spot” of the Image 1, the Image 1 data 205 is interlaced to the original pixel columns 105 and 135 as well as to the pixel columns 115 and 145 associated with the adjacent viewing angle 221. Instead of displaying three images at different angles, there are now two images, Images 1 and 3, with the Image 1 being displayed over two adjacent viewing angles 21 land 221.

FIG. 6b illustrates another example of how images are interlaced to increase a “sweet spot” or viewable are, and the example case of three images, Image 1, Image 2 and Image 3 is used, produced by their associated image data 205, 215 and 225, respectively. To increase the “sweet spot” of Image 2, the Image 2 data 215 is interlaced to the original pixel columns 115 and 145 as well as the pixel columns 125 and 155 associated with the adjacent viewing angle 201. Instead of displaying three images at different angles, there are now two images, Images 1 and 2, with Image 2 being displayed over two adjacent viewing angles 201 and 221. FIG. 6a and FIG. 6b show two possible embodiments from a plurality of possible embodiments for combining viewing angles to increase the “sweet spot” or viewable area. In other embodiments, a single image can be interlaced to more than two viewable angles. In other embodiments, an image may be interlaced to non-adjacent viewing angles 201 and 211.

In another embodiment, instead of using parallax barriers to create multiple images for multiple views, other methods such as lenticular overlays or angled light pipes may be used to achieve the same visual effect. Additionally, pixel groupings are not limited to columns of pixels. Using angled light pipes or lenticular overlays, pixels may be grouped into plurality of different blocks or configurations.

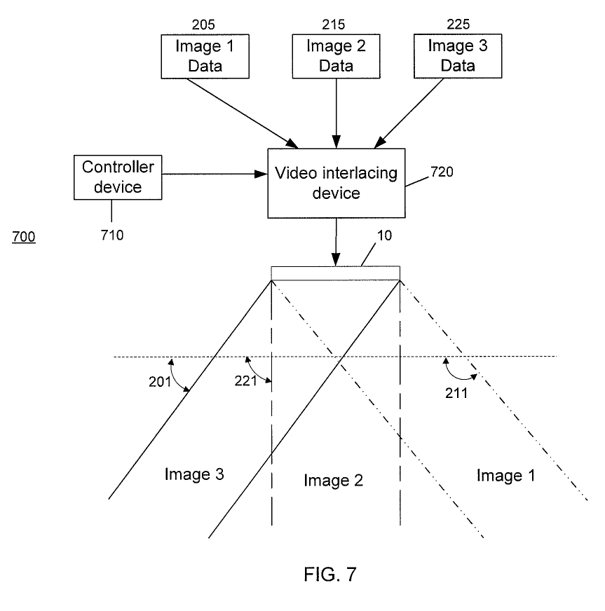

FIG. 7 illustrates an example of a block diagram showing select components of a system 700 according to one embodiment. The system 700 comprises a controller device 710, a video interlacing device 720 and a display device 10 according to any of the embodiments described herein. In the example shown in FIG. 7, image data 205, 215 and 225 for Images 1, 2 and 3, respectively, are received by the video interlacing device 720 and interlaced into one video signal. The controller device 710 determines which image data 205, 215 and 225 is displayed at a particular angle in the plurality of viewing angles 201, 211 and 221. This video signal is displayed on the display device 10 that is configured to show the three images (Images 1, 2 and 3) at different angles 201, 211 and 221, relative to a viewing surface of the display device 10. During the course of displaying Images 1, 2 and 3 the controller device 710 may instruct the video interlacing device 720 to change the sequence of interlaced image data 205, 215 and 225 such that an image may appear on a different angle 201, 211 and 221.

The controller device 710 may also instruct the video interlacing device 720 to interlace the same video image onto more than one viewing angle. For example, the controller device 710 may instruct the video interlacing device to interlace image data 205 to two viewing angles 201 and 221 and to interlace image data 215 to a third viewing angle 211. By interlacing image data 205 to two adjacent angles 201 and 221 the range of viewable angles increases from one range 201 to two ranges 201 and 221 for Image 1. Note, FIG. 7 and the above examples illustrate several possible viewing configurations in a plurality of possible viewing configurations. Additionally, more and fewer images and possible viewing angles are contemplated within the scope of embodiments described herein.

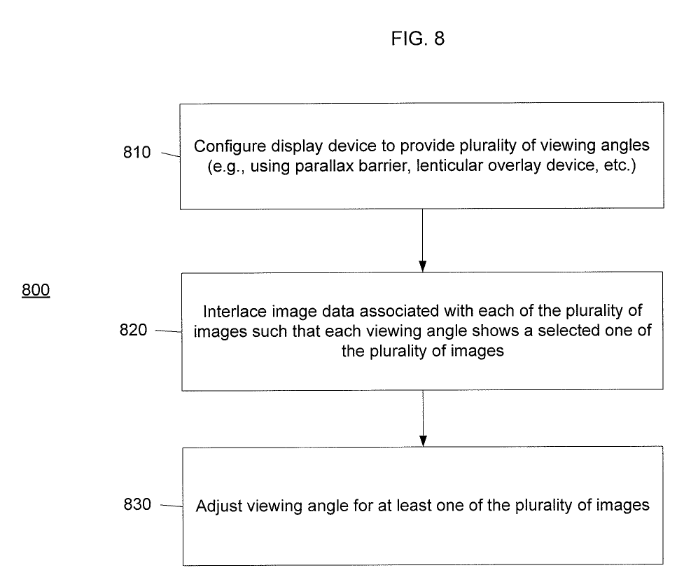

FIG. 8 illustrates an example of a flow chart depicting a method 800 that exploits the techniques and configurations described herein. At 810, a display device, e.g., display device 10 according to any of the embodiments described herein, is configured to provide a plurality of viewing angles. This may involve using an optical element such as an parallax barrier, a lenticular overlay device or any other optical element suitable for creating a plurality of viewing angles. At 820, image data associated with each of a plurality of images is interlaced such that each viewing angle displays a selected one of the plurality of images. This may involve interlacing the image data such that all of the viewing angles display different images, some of the viewing angles display one of the plurality of images while other viewing angles display a different one of the plurality of images, etc. At 830, the viewing angle is adjusting for at least one of the plurality of images. Any one or more of the various interlacing techniques described above may be employed at 820 and any one or more of the viewing angle adjustments techniques described above may be employed at 830. For example, at 830, the relative position of a parallax barrier with respect to a display panel may be adjust to provide different numbers of viewing angles and to adjust the spacing between the viewing angles.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as examples only, with a true scope and spirit being indicated by the following claims.

What is claimed is:

1. A method comprising:
configuring a display to provide a plurality of viewing angles;
interlacing image data associated with each of a plurality of images such that each viewing angle displays a selected one of the plurality of images; and
adjusting a viewing angle for at least one of the plurality of images.

2. The method of claim 1, wherein the display is one of a plurality of displays used in an endpoint of a videoconference.

3. The method of claim 1, wherein configuring the display to provide the plurality of viewing angles comprises using a lenticular overlay device to create the plurality of viewing angles.

4. The method of claim 1, wherein configuring the display to provide the plurality of viewing angles comprises using a parallax barrier to create the plurality of viewing angles.

5. The method of claim 1, wherein interlacing comprises interlacing the image onto a pixel group associated with the viewing angle on the display such that all pixels in the group are interlaced with the same image data.

6. The method of claim 1, wherein adjusting comprises increasing a range of viewing angles for one of the plurality of images.

7. The method of claim 6, wherein increasing a range of viewing angles comprises interlacing the same image data for one of the plurality of images to multiple viewing angles among the plurality of viewing angles.

8. The method of claim 7, wherein interlacing comprises interlacing image data for one of the plurality of images to at least two adjacent viewing angles.

9. The method of claim 1, wherein adjusting comprises decreasing a viewing angle for one of the plurality of images by decreasing the number of viewing angles to which image data is interlaced for the image.

10. A system comprising:
a display device configured to provide a plurality of viewing angles;
a video interlacing device operably connected to the display and configured to interlace image data for each of a plurality of images into a video stream such that each viewing angle displays a selected one of the plurality of images; and
a controller device operably connected to the video interlacing device, wherein the controller device is configured to change a range of viewing angles for at least one of the plurality of images.

11. The system of claim 10, wherein the display is configured to provide the plurality of viewing angles comprises the display by providing a unique one of the plurality of viewing angles for one of a plurality of pixel groups on the display.

12. The system of claim 11, wherein the display is configured to provide the unique viewing angle by adjusting the viewing angles for one of the plurality of pixel groups such that pixels in that group are viewable from the same relative range of viewing angles.

13. The system of claim 12, wherein the display is configured to provide:
a first range of viewing angles among the plurality of viewing angles at which a first image among the plurality of images is viewable; and
a second range of viewing angles among the plurality of viewing angles at which a second image among the plurality of images is viewable.

14. The system of claim 13, wherein the display device is configured to provide the first range of viewing angles and the second range of viewing angles such that the first range of viewing angles and the second range of viewing angles are adjacent.

15. The system of claim 10, wherein the video interfacing device is configured to respond to instructions from the controller device to interlace at least one of the plurality of images to a range of viewing angles among the plurality of viewing angles.

16. The system of claim 10, wherein the controller device is configured to increase the viewing range of at least one of the plurality of images.

17. The system of claim 16, wherein the controller device is configured to increase the viewing angle by instructing the video interlacing device to interlace the image data associated with the at least one image onto pixel groups associated with a first and a second range of viewing angles.

18. The system of claim 16, wherein the controller device is further configured to not interlace image data associated another of the plurality of images to the second range of viewing angles.

19. The system claim of 10, wherein the controller device is configured to decrease the viewing angle of at least one of the plurality of images.

20. The system claim of 19, wherein the controller is configured to instruct the video interlacing device to interlace image data associated with the at least one of the plurality of images to a first range of viewing angles.

21. The system claim of 20, wherein the controller is configured to instruct the video interlacing device to not interlace the image data associated with said at least one image to a second range of viewing angles.

22. The system claim of 21, wherein the controller is configured to instruct the video interlacing device to interlace image data associated with another of the plurality of images to the second range of viewing angles.

23. The system of claim 10, wherein the display device comprises a display panel and an optical element positioned adjacent the display panel, wherein the optical element is configured to create the plurality of viewing angles.

24. The system of claim 23, wherein the optical element is a parallax barrier.

25. The system of claim 23, wherein the optical element is a lenticular overlay device.
